(19) United States
(12) Patent Application Publication
(10) Pub. No.: US 2004/0172501 A1
(43) Pub. Date: Sep. 2, 2004

(54) Metadata allocation method in a storage system

(75) Inventors: Toshiyuki Ukai, Machida (JP); Yoshifumi Takamoto, Kokubunji (JP)

Correspondence Address: REED SMITH LLP, 3110 FAIRVIEW PARK DRIVE, SUITE 1400, FALLS CHURCH, VA, 22042, US

(73) Assignee: Hitachi, Ltd.

(21) Appl. No.: 10/641,069

(22) Filed: Aug. 15, 2003

(30) Foreign Application Priority Data
Feb. 28, 2003 (JP) 2003-54397

(51) Int. Cl. G06F 12/00

(52) U.S. Cl. 711/112; 711/170

(57) ABSTRACT

In a computer system which improves reliability by switching over hosts 101 and 102 between which logical volumes are shared when a fault occurs, metadata present on physical volumes 104 and necessary to constitute the logical volumes 104 is consolidated and allocated in a fewer number of physical volumes than the number of the physical volumes. It is thereby possible to accelerate the reading of metadata and the switchover of the shared logical volumes.

### TECHNICAL FIELD OF THE INVENTION

The present invention relates to volume management by means of logical volumes, and particularly relates to a technique effective to be applied to the shortening of time for making logical volumes usable.

### BACKGROUND OF THE INVENTION

In many operating systems, volume management is mainly carried out by means of logical volumes. A logical volume is a virtual volume which is newly defined from a group of one or more physical volumes (a volume group).

The logical volume enables abstracting volumes used as a file system and managing a virtual storage that is separated from physical volumes.

The use of the logical volume enables flexible volume management in a computer system. For example, if the logical volume is used, a plurality of disk drives can be consolidated and used as a single volume. Conversely, one large volume can be used as a plurality of small volumes.

If there is no free space in the file system, the capacity of the logical volume can be increased by adding a physical volume to the volume group.

To realize such a logical volume, the operating system stores in the physical volume the metadata for managing volume group as information for managing the logical volume.

The volume group management metadata is information on the configuration of the volume group and the configuration of the logical volume including logical-physical mapping. The metadata of this type is often updated when the configuration of the volume group or the logical volume is changed, so that the update frequency of the metadata is relatively low.

Normally, metadata and ordinary data are allocated at distant locations in the same volume (which may be either “a physical volume” or “a logical volume”, depending on the hierarchy of software). For this reason, if the metadata is frequently updated, the input/output of the metadata sometimes adversely influences or deteriorates ordinary data input/output performance.

QFS provided by Sun Microsystems (“Sun QFS”) disclosed in “Technical Overview Sun QFS” (Sun Microsystems, August 2001) can separate metadata (e.g., i node) from ordinary data in a file system and allocate the metadata and the ordinary data in different devices (volumes).

Meanwhile, there is known a method for realizing optimum allocation of not only metadata but also any other data using the characteristic of a secondary storage device (see Japanese Patent Application Laid-Open No. 2001-273176 or U.S. Pat. No. 5,619,690, for example).

According to the method disclosed in the document, if a region for newly storing data is to be allocated, means for determining an allocation target block in a secondary storage device and notifying a host of the determined block is prepared.

According to this method, the secondary storage device can optimally allocate data. Therefore, if this feature is used to determine metadata allocation, it is possible to allocate the metadata at a location where metadata has a smaller influence on access to ordinary data.

### SUMMARY OF THE INVENTION

The inventors of the present invention discovered that the conventional technique for volume management by means of logical volumes has the following disadvantages.

If logical volumes are used in a computer system, the operating system reads group management metadata and performs a processing for making logical volumes usable (volume group activation processing) based on the information.

The volume group management metadata is stored in each physical volume. Due to this, the more the physical volumes are, the longer the time becomes until the logical volume can be used. If a highly reliable system which shares a disk drive among a plurality of hosts is constructed, this increase results in an increase in system switchover time. It is, therefore, necessary to accelerate the reading of volume group management metadata.

If metadata and ordinary data are separated from each other and allocated in different devices in a file system, a metadata dedicated volume and an ordinary data dedicated volume can be used in a single file system.

By adopting such a configuration, the system prevents metadata update from influencing input/output of the ordinary data. According to this method, however, each volume is either a metadata dedicated volume or an ordinary data dedicated volume. Due to this, if one of the volumes is inaccessible due to a fault or the like, it is disadvantageously difficult to read not only part of data but only entire data on the file system.

Furthermore, if optimum data allocation is realized by using the characteristic of the secondary storage device, the secondary storage device determines locations for allocating data on volumes. If this method is applied to metadata, it is disadvantageously necessary to notify the secondary storage device whether the data for which a storage location is to be determined is metadata or not.

It is an object of the present invention to provide a metadata allocation method in a storage system, a program, and a disk drive capable of accelerating the reading of metadata and accelerating the switchover of shared logical volumes followed by host switchover by consolidating a fewer number of physical or logical volumes than the number of the physical volumes and allocating the consolidated volumes.

The above and other objects of the present invention and novel features of the present invention will be readily apparent from the reading of the description of this specification and accompanying drawings.

Among the inventions disclosed in the present application, the outline of a typical invention will be briefly described as follows:

(1) A metadata allocation method in a computer system, the computer system including: one or more computers; and a plurality of physical or logical secondary storage devices, an OS (Operating System) of the computer having: a function of consolidating the plurality of physical or logical secondary storage devices so as to manage the consolidated physical or logical secondary storage device as a logical storage device; and a function of allocating metadata in a first region on the physical or logical secondary storage device in order to manage the consolidated physical or logical secondary storage devices as the logical storage device, the method including a step of allocating in a second region a copy of the metadata for managing the plurality of physical or logical secondary storage devices as the logical storage device, said second region satisfying a predetermined condition on a fewer number of the physical or logical secondary storage devices than the number of the physical or logical secondary storage regions each having the first region.

Further, the outline of the other inventions of the present application will be briefly described as follows:

(2) A metadata allocation method in a computer system, the computer system including: a plurality of computers; and a plurality of physical or logical secondary storage devices, an OS of the computer having: a function of consolidating the plurality of physical or logical secondary storage devices so as to manage the consolidated physical or logical secondary storage device as a logical storage device; and a function of allocating metadata in a first region on the physical or logical secondary storage device in order to manage the consolidated physical or logical secondary storage devices as the logical storage device, the method including a step of allocating in a second region a copy of the metadata for managing the plurality of physical or logical secondary storage devices as the logical storage device, said second region satisfying a predetermined condition on a fewer number of the physical or logical secondary storage devices than the number of the physical or logical secondary storage regions each having the first region, wherein the plurality of computers share the plurality of physical or logical secondary storage devices, and in the case where the first computer among the plurality of computers turns into an abnormal status, the copy of the metadata allocated in the second regions is read when the second computer succeeds a processing of the first computer.

(3) A metadata allocation method in a computer system, the computer system including: one or more computers; and a plurality of physical or logical secondary storage devices, an OS of the computer having: a function of consolidating the plurality of physical or logical secondary storage devices so as to manage the consolidated physical or logical secondary storage device as a logical storage device; and a function of allocating metadata in a region on the physical or logical secondary storage device in order to manage the consolidated physical or logical secondary storage devices as the logical storage device, wherein the region is set to reside in a cache memory of the secondary storage device.

(4) A program for allowing a computer system to execute a procedure, the computer system including: one or more computers; and a plurality of physical or logical secondary storage devices, an OS of the computer having: a function of consolidating the plurality of physical or logical secondary storage devices so as to manage the consolidated physical or logical secondary storage device as a logical storage device; and a function of allocating metadata in a first region on the physical or logical secondary storage device in order to manage the consolidated physical or logical secondary storage devices as the logical storage device, the procedure being for allocating in a second region a copy of the metadata for managing the plurality of physical or logical secondary storage devices as the logical storage device, said second region satisfying a predetermined condition on a fewer number of the physical or logical secondary storage devices than the number of the physical or logical secondary storage regions each having the first region.

(5) A program for allowing a computer system to execute a procedure, the computer system including: a plurality of computers; and a plurality of physical or logical secondary storage devices, an OS of the computer having: a function of consolidating the plurality of physical or logical secondary storage devices so as to manage the consolidated physical or logical secondary storage device as a logical storage device; and a function of allocating metadata in a first region on the physical or logical secondary storage device in order to manage the consolidated physical or logical secondary storage devices as the logical storage device, the procedure being for allocating in a second region a copy of the metadata for managing the plurality of physical or logical secondary storage devices as the logical storage device, said second region satisfying a predetermined condition on a fewer number of the physical or logical secondary storage devices than the number of the physical or logical secondary storage regions each having the first region, wherein the plurality of computers share the plurality of physical or logical secondary storage devices, and wherein in the case where the first computer among the plurality of computers turns into an abnormal status, the copy of the metadata allocated in the second regions is read when the second computer succeeds a processing of the first computer.

(6) A disk drive including one or more physical secondary storage devices, wherein the disk drive has a function of consolidating the physical secondary storage devices to provide one or more logical secondary storage devices, and includes a cache memory in which a predetermined region of the one or more logical secondary storage devices is made to reside.

### BRIEF DESCRIPTIONS OF THE DRAWINGS

FIG. 1 is a block diagram illustrating a computer system in the first embodiment according to the present invention;

FIG. 2 is an explanatory view illustrating one example of logical volume management metadata present in a physical volume in the computer system shown in FIG. 1;

FIG. 3 is an illustration of one example of a volume group configuration management table in the computer system shown in FIG. 1;

FIG. 4 is a block diagram illustrating one example of a consolidated metadata region management table in the computer system shown in FIG. 1;

FIG. 5 is an explanatory view illustrating the outline of consolidated metadata allocation in the computer system shown in FIG. 1;

FIG. 6 is a flow chart for a volume group activation processing in the computer system shown in FIG. 1;

FIG. 7 is a flow chart for a consolidated metadata read mechanism in the computer system shown in FIG. 1;

FIG. 8 is a flow chart for a consolidated metadata write mechanism in the computer system shown in FIG. 1;

FIG. 9 is an explanatory view illustrating the outline of consolidated metadata allocation in a computer system in the second embodiment according to the present invention;

FIG. 10 is a flow chart for a cache residence registration processing in the computer system shown in FIG. 9;

FIG. 11 is an explanatory view illustrating the outline of consolidated metadata allocation in a computer system in the third embodiment according to the present invention; and

FIG. 12 is an explanatory view illustrating the outline of consolidated metadata allocation in a computer system in the fourth embodiment according to the present invention.

### DESCRIPTION OF THE PREFERRED EMBODIMENTS

Embodiments of the present invention will be described hereinafter in detail with reference to the drawings.

(First Embodiment)

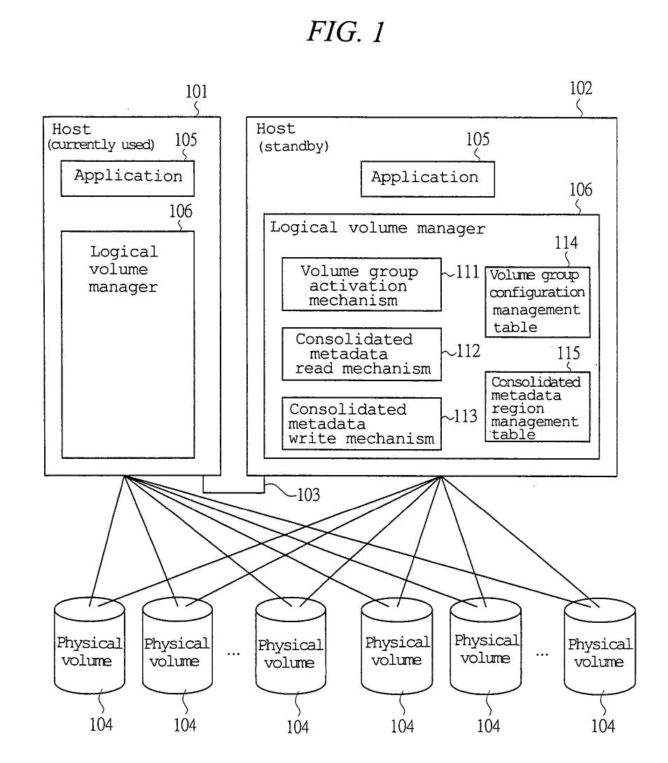

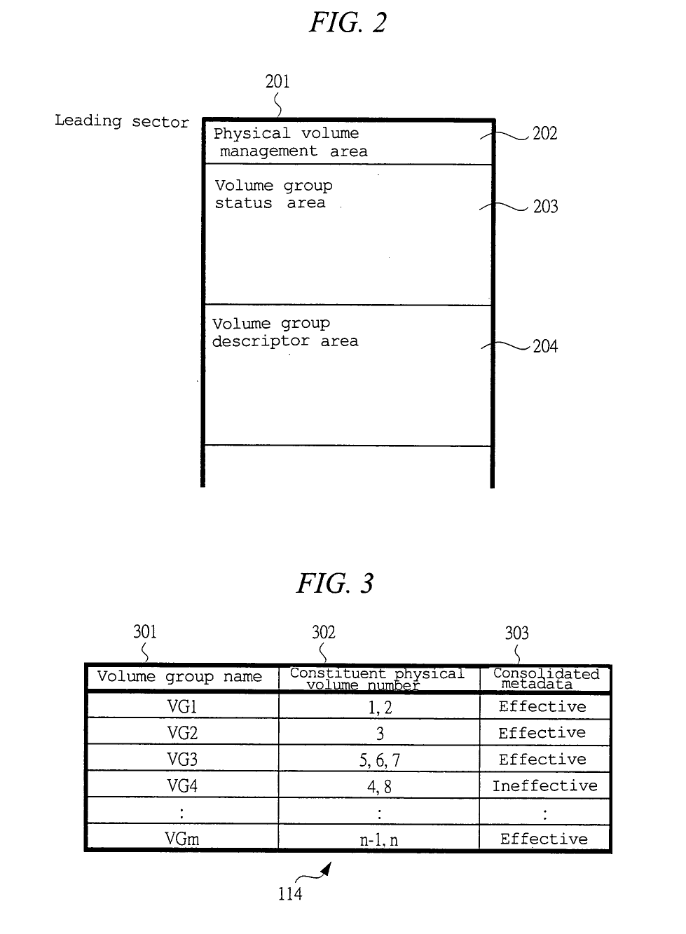

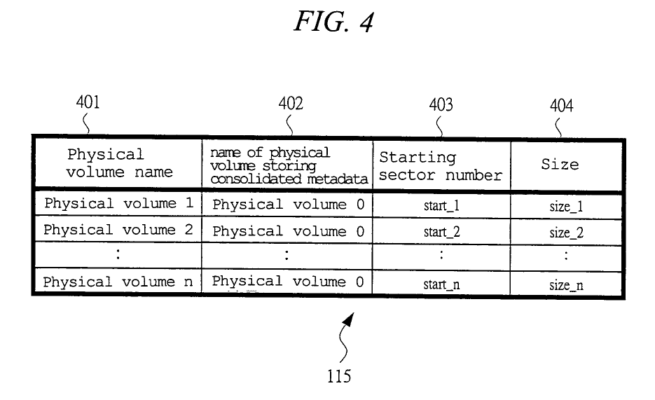

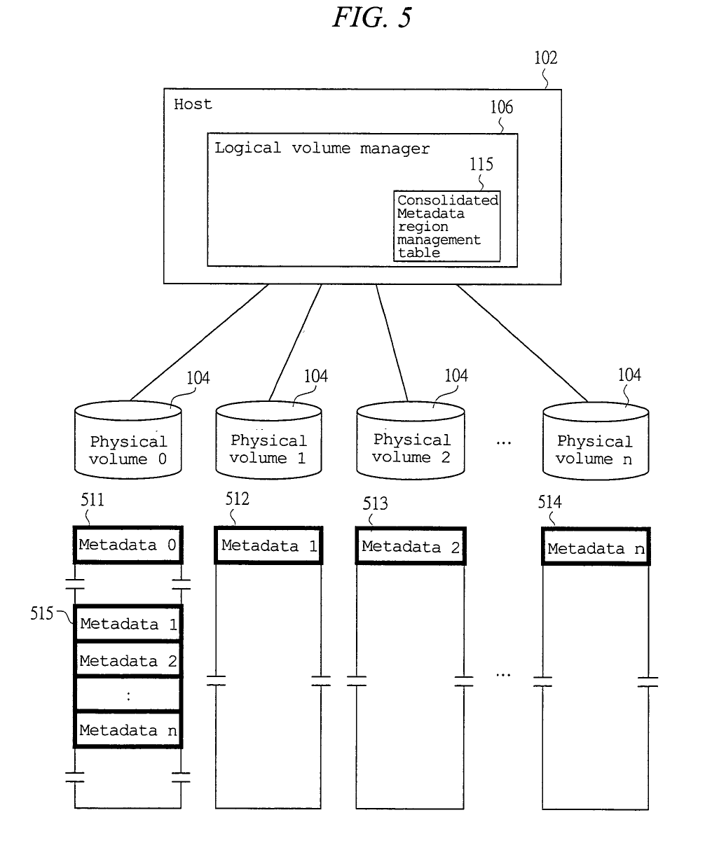

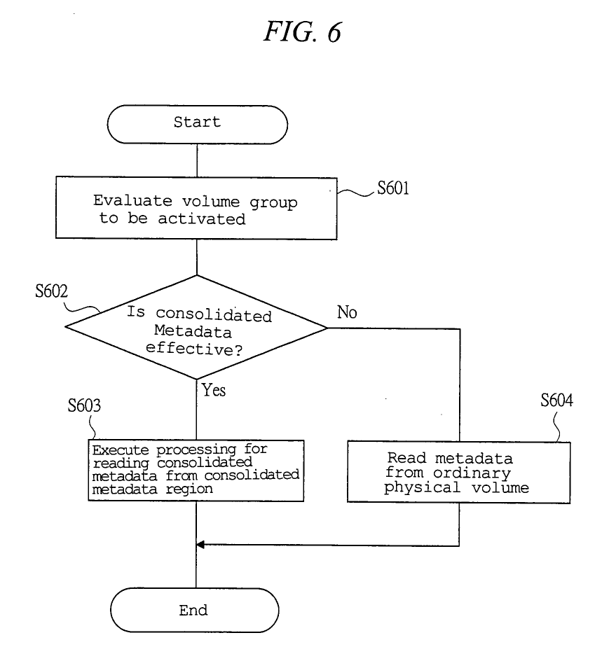

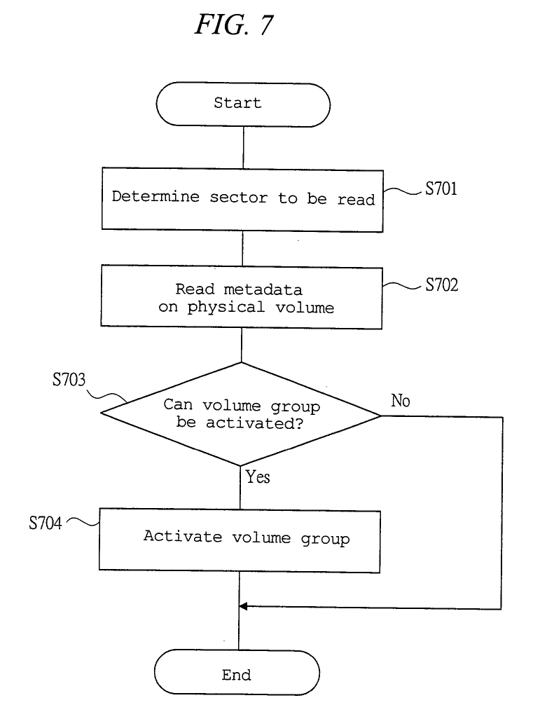

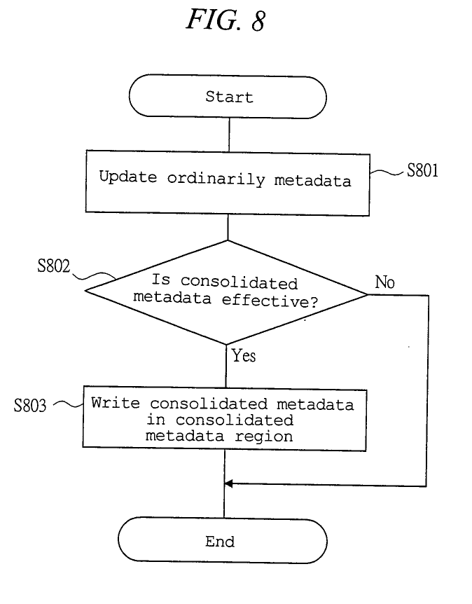

FIG. 1 is a block diagram illustrating a computer system in the first embodiment according to the present invention. FIG. 2 is an explanatory view illustrating one example of logical volume management metadata present in a physical volume in the computer system shown in FIG. 1. FIG. 3 is an illustration of one example of a volume group configuration management table in the computer system shown in FIG. 1. FIG. 4 is a block diagram illustrating one example of a consolidated metadata region management table in the computer system shown in FIG. 1. FIG. 5 is an explanatory view illustrating the outline of consolidated metadata allocation in the computer system shown in FIG. 1. FIG. 6 is a flow chart for a volume group activation processing in the computer system shown in FIG. 1. FIG. 7 is a flow chart for a consolidated metadata read mechanism in the computer system shown in FIG. 1. FIG. 8 is a flow chart for a consolidated metadata write mechanism in the computer system shown in FIG. 1.

The computer system in the first embodiment comprises hosts (computers) 101 and 102 as shown in FIG. 1. The hosts 101 and 102 are connected to each other by a network 103 and physical volumes 104 are shared between the hosts 101 and 102.

The physical volumes mentioned herein are volumes which can be seen as “physical volumes” from the hosts 101 and 102. It does not matter whether each physical volume is a disk drive or a disk array device. In addition, a volume which is made to logically appear a disk drive by the disk drive can serve as a physical volume.

In each of the hosts 101 and 102, various applications 105 and a logical volume manager 106 such as an operating system (OS) serving as a part of system software operate. The logical volume manager 106 converts access to a logical volume from the application 105 or the like into access to a physical volume.

Further, the hosts 101 and 102 communicate with each other through the network 103 and constitute a hot-standby configuration. In the case where a fault occurs to the currently used host 101, the host 101 is switched over to the other or standby host 102, so that an application processing or the like can be continued.

In this embodiment, a volume group activation function 111, a consolidated metadata read mechanism 112, a consolidated metadata write mechanism 113, a volume group configuration management table 114, and a consolidated metadata region management table 115 are provided in the volume manager 106, thereby imparting a function of accelerating logical volume switchover followed by host switchover to each host.

FIG. 2 is an explanatory view illustrating one example of metadata 201 for logical volume management residing in a physical volume.

The metadata 201 is divided into a physical volume management area 202, a volume group status area 203, a volume group descriptor area 204 and the like from the top of the physical volume.

The physical volume management area 202 holds closed information in the physical volume such as the identifier of the physical volume and fault sector information on the physical volume. The volume group status area 203 holds the status of the entire physical volumes that constitute a volume group. The volume group descriptor area 204 holds the identifier of the volume group and information on the logical-physical mapping of the volume group.

The identifier of the physical volume held in the physical volume management area 202 is used by the OS to uniquely identify the physical volume and specify the physical or logical connection location of the physical volume (recognize the configuration of the physical volume). The physical volume, the connection location of which is specified, is registered in a configuration table managed by the OS and can be correctly accessed by the OS. Needless to say, any arbitrarily means can be used for identifying each physical volume as long as the physical volume can be uniquely recognized.

This configuration recognition processing is normally performed when the system is activated. However, this processing can be performed at time other than the system activation time. It suffices to execute the processing at least before host computer switchover occurs. If a nonvolatile memory is mounted in the host computer, the physical volume or the like and the memory holds a table, there is no need to execute the configuration recognition processing whenever the computer reboots.

The outline of the configuration recognition processing will be described.

Each of the host computers 101 and 102 reads the physical volume identifier of each physical volume 104 connected to the computer, relates the physical volume 104 to its logical or physical connection location, and registers the resultant physical volume 104 in the configuration table managed by the OS. However, in the case where the configuration of the physical volume when the system was activated is changed during operation of the system by, for example, the activation of the volume or the change of the location at which the volume is connected, it is necessary to re-execute the configuration recognition processing and update the configuration table managed by the OS.

FIG. 3 is an illustration of one example of the configuration of the volume group configuration management table 114.

This volume group configuration management table 114 represents whether consolidated metadata is effective or ineffective in the respective physical volumes that constitute each volume group.

A volume group name column 301 shows the names of volume groups defined in this computer system. A column 302 shows the names of physical volumes that constitute each volume group.

A column 303 shows whether consolidated metadata is effective or ineffective in each group. As for a volume group VG1, for example, it is indicated in the table 114 that the volume group VG1 comprises physical volumes 1 and 2, consolidated metadata is effective in VG1, and that metadata is consolidated.

FIG. 4 is an illustration of one example of the configuration of the consolidated metadata region management table 115.

This consolidated metadata region management table 115 represents a location where the consolidated metadata on each physical volume, for which the volume group configuration management table shown in FIG. 3 represents that the consolidated metadata is effective, is stored.

A column 401 shows the names of physical volumes. A column 402 shows in which physical volume, consolidated metadata on each physical volume is stored. A column 403 holds the starting sector number of each storage location of the consolidated metadata. A column 404 holds the size (the number of sectors) of each metadata. Due to this, it is possible to clarify the storage location of the consolidated metadata on each physical volume the consolidated metadata of which is effective.

FIG. 5 illustrates the outline of consolidated metadata allocation in this system. Namely, FIG. 5 illustrates one example in which (n+1) physical volumes 104 shared between the hosts 101 and 102 are connected to the host 102.

The shared physical volumes 104 hold metadata 1 to n to manage the physical volumes in the leading parts of storage regions (first regions) 511 to 514, respectively. FIG. 5 illustrates one example in which consolidated metadata on each of the physical volumes 1 to n is effective at this moment in the consolidated metadata region management table 115 of the host 102, and that the storage location of the consolidated metadata is the physical volume 0. The storage position of a consolidated metadata storage region (second region) 515 may be arbitrarily selected. However, in light of read efficiency, it is advantageous to allocate the second region 515 in a continuous region.

As shown in FIG. 5, if consolidated metadata is effective, copies of the metadata 1 to n allocated in the leading parts of the respective original physical volumes 104 are used as the consolidated metadata. Accordingly, even if a fault occurs to the physical volume 0 and the consolidated metadata cannot be read, it is possible to continue a volume group activation processing by reading the metadata 1 to n allocated in the leading parts of the respective physical volumes.

FIG. 6 is a flow chart for the volume group activation processing. Although not shown in FIG. 6, this processing is executed when software or hardware that controls the host computers constituting the hot-standby configuration determines that a fault occurs to the currently used computer and the currently used computer should be switched over tb the standby host computer.

First, following host switchover, a volume group to be activated on the standby host side is evaluated (in a step S601). This evaluation is performed by the application or the like which controls system switchover.

After evaluation, the logical volume manager 106 receives information on the to-be-activated volume group and actually executes a volume group activation processing.

At this moment, the volume group configuration management table 114 determines whether consolidated metadata on this volume group is effective (in a step S602).

If it is determined in the step S602 that the consolidated metadata is effective, a consolidated metadata read processing is executed (in a step S603). If it is determined in the step S602 that the consolidated metadata is ineffective, physical volume metadata is read from the leading part of each physical volume.

FIG. 7 is a flow chart for a consolidated metadata read mechanism.

The consolidated metadata region management table 115 is referred to, a physical volume which holds consolidated metadata is specified, a sector to be read is determined (in a step S701), and consolidated metadata is actually read (in a step S702).

Thereafter, using the read consolidated metadata, it is evaluated whether a volume group can be activated (in a step S703). The evaluation may be performed either bated on a conventional standard or by determining whether the physical volume is in a ready state. Further, using the physical volume identifier held in the read consolidated metadata, a processing for specifying the logical or physical connection location of the physical volume corresponding to the read consolidated metadata is performed based on the configuration table which is created in advance during the configuration recognition processing and which represents the relation of the respective physical volumes to the logical or physical connection locations. If it is determined that the volume group can be activated, the volume group is activated (in a step S704). If it is determined that the volume group cannot be activated, the consolidated metadata read processing is finished.

FIG. 8 is a flow chart for a consolidated metadata write mechanism.

If metadata is to be updated, the metadata allocated in the leading part of the physical volume is updated as usual (in a step S801).

The volume group configuration management table 114 determines whether consolidated metadata on the volume group is effective (in a step S802). If it is determined that the consolidated metadata is effective, a consolidated metadata update processing is executed (in a step S803). If it is determined that the consolidated metadata is ineffective, the consolidated metadata write processing is finished.

As can be seen, in this embodiment, the reading of the metadata on each physical volume necessary for the processing (volume group activation processing) to make the physical volumes 104 usable during the host switchover can be accelerated by reading the consolidated data first.

In addition, even if the consolidated metadata is used, metadata allocated in each physical volume 104 can be also used. Therefore, even if the consolidated metadata cannot be read, the volume group activation processing can be executed without the need to perform a special processing.

(Second Embodiment)

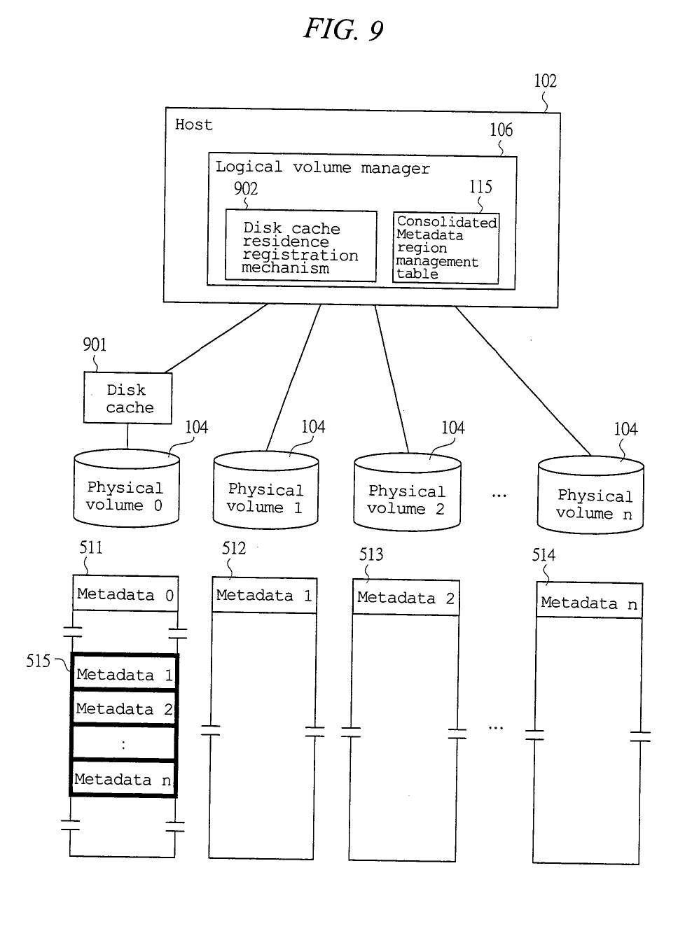

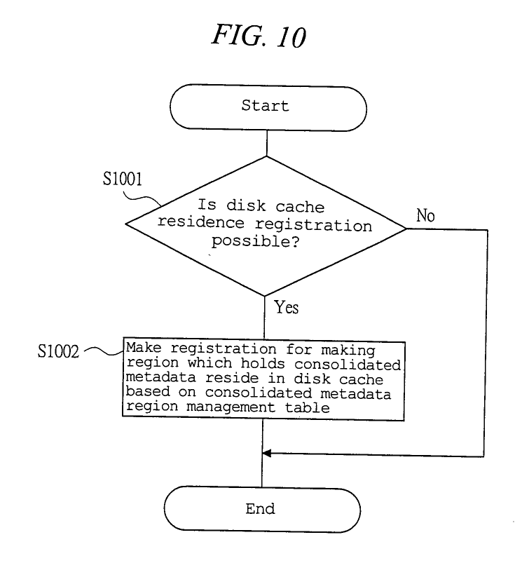

FIG. 9 is an explanatory view illustrating the outline of consolidated metadata allocation in a computer system in the second embodiment according to the present invention. FIG. 10 is a flow chart for a cache residence registration processing in the computer system shown in FIG. 9.

In the second embodiment, FIG. 9 illustrates the outline of the computer system and that of consolidated metadata allocation. FIG. 9 differs from FIG. 5 which illustrates the first embodiment in that a disk cache 901 is provided and that a disk cache residence registration mechanism 902 is provided in the logical volume manager 106.

The disk cache 901 is used to effectively input and output data to and from physical media that constitute each physical volume 104 when the host 102 inputs and outputs data to and from the physical volume without being conscious of the presence of the disk cache 901.

It is assumed herein that each physical volume 104 provides the host 102 with an interface which enables an arbitrary sector of the physical volume 104 to reside in the disk cache 901.

A processing for an input/output request for the sector that is set to reside in the disk cache 901 is completed by the input and output of data to and from the disk cache 901 once the data is stored in the disk cache 901.

The second embodiment is the same as the first embodiment in the processes performed until consolidated metadata is activated. The second embodiment, however, differs from the first embodiment in that the region of the physical volume 0 which stores the consolidated metadata is set to reside in the disk cache 901 by the disk cache residence registration mechanism 902.

If the region that stores the consolidated metadata is set resident in the disk cache 901, the reading of metadata performed by switching logical volumes in the hot-standby configuration of the hosts can be further accelerated, whereby switchover can be accelerated.

FIG. 10 is a flow chart for the disk cache residence registration mechanism 902.

First, it is evaluated whether disk cache residence registration is possible (in a step S1001). This evaluation is intended to determine whether the number of entries and the size of the region registered to reside in the disk cache 901 do not exceed respective limitations.

If it is evaluated that registration is impossible, the processing is finished. If registration is possible, a registration for making the region which holds the consolidated metadata reside in the disk cache 901 is made based on the consolidated metadata region management table 115 (in a step S1002).

As can be seen, in the second embodiment, besides the metadata consolidation advantage of the first embodiment, it is possible to further accelerate the reading of metadata and further accelerate the processing for making logical volumes usable during host switchover by making the consolidated metadata storage location determined by the host 102 reside in the disk cache 901.

Furthermore, since the host 102 recognizes that it is effective to read metadata at high rate in a case like the second embodiment, the disk cache 901 can be advantageously, efficiently used to this end.

(Third Embodiment)

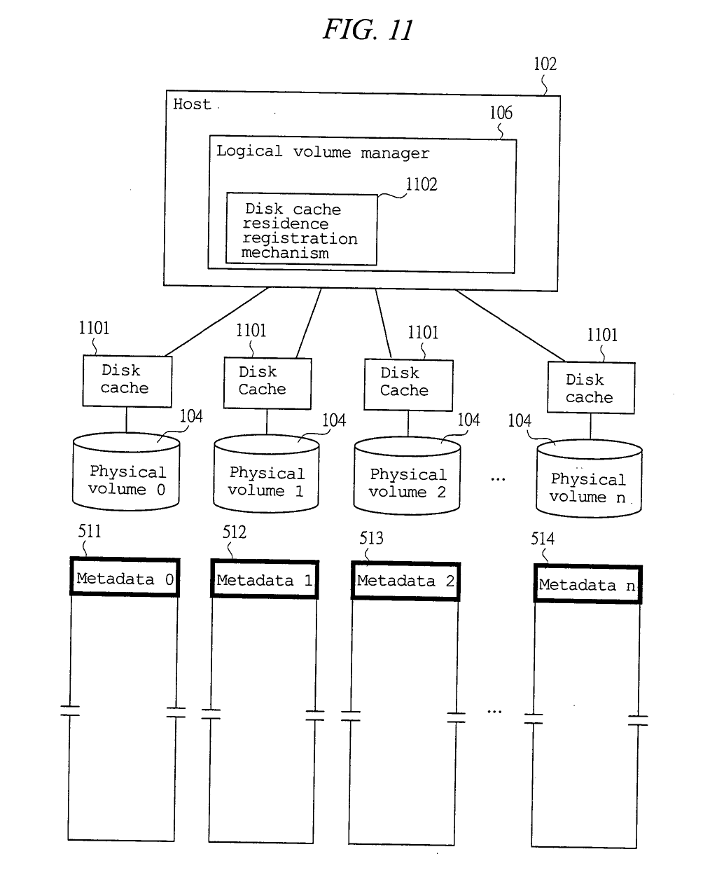

FIG. 11 is an explanatory view illustrating the outline of consolidated metadata allocation in a computer system in the third embodiment according to the present invention.

In the third embodiment, FIG. 11 illustrates the outline of the computer system and that of consolidated metadata allocation. FIG. 11 differs from FIG. 9 which illustrates the second embodiment in that disk caches 1101 similar to the disk cache 901 shown in FIG. 9 are provided for the respective physical volumes 104, the consolidated metadata region management table 114 is not provided in the logical volume manager 106, and in that consolidated metadata is not provided, accordingly.

In the third embodiment, the host 102 registers metadata 0 to n in the leading parts of physical volumes 0 to n to reside in disk caches 1101, respectively. It is thereby possible to accelerate the reading of metadata and accelerate a processing for making logical volumes usable at the time of host switchover without using the consolidated metadata.

A disk cache residence registration mechanism 1102 in the logical volume manager 106 registers storage regions 511 to 514 of the metadata 0 to n in the physical volumes 0 to n in the respective disk caches 1101 based on the consolidated metadata region management table instead of making a disk cache residence registration in the step S1002 shown in FIG. 10.

As can be seen, in the third embodiment, the metadata regions of the physical volumes 104 are made to reside in the respective caches 1101 without using the consolidated metadata, whereby it is possible to accelerate the reading of metadata and accelerate a processing for making logical volumes usable at the time of host switchover without using the consolidated metadata.

(Fourth Embodiment)

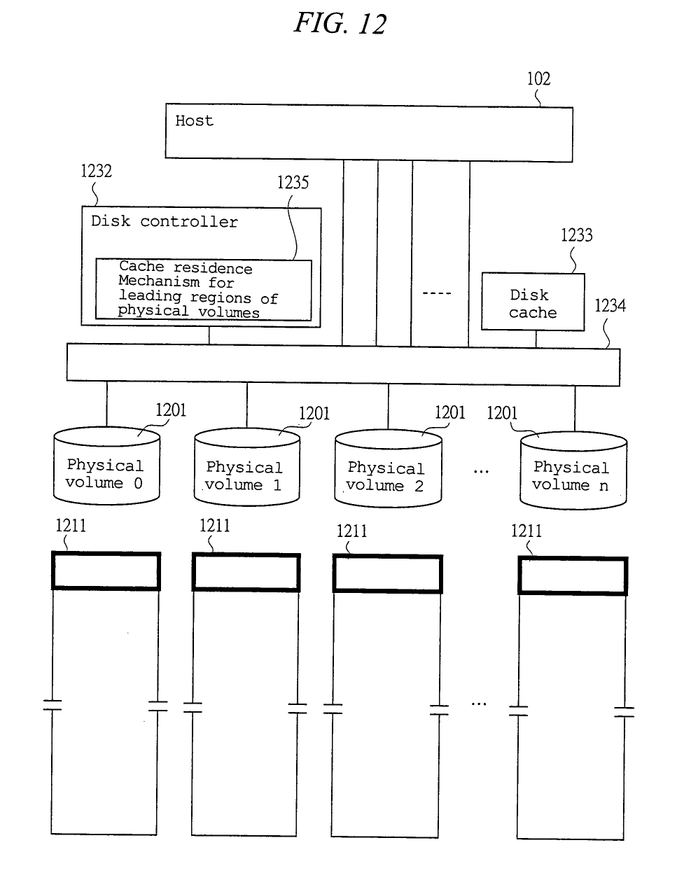

FIG. 12 is an explanatory view illustrating the outline of consolidated metadata allocation in a computer system in the fourth embodiment according to the present invention.

In the fourth embodiment, FIG. 12 illustrates the outline of the computer system and that of consolidated metadata allocation. A disk drive connected to the host 102 comprises a disk controller 1232, a disk cache 1233, a switch 1234 and true physical storages.

In this disk drive, the disk controller 1232 makes the true physical storages appear physical volumes 1201 to the host 102 in the form of logically reconstructing the storages.

Metadata used to realize each logical volume 1201 is often allocated in the leading part of the physical volume 1201. Due to this, in this embodiment, a cache residence mechanism 1235 for the leading regions of the respective physical volumes 1201 is prepared in the disk controller 1232, and the leading regions 1211 of the respective physical volume 1201 are set to reside in the disk cache 1233 in advance.

As can be seen, in the fourth embodiment, the disk drive makes the leading region 1211 of each physical volume 1201 reside in the disk cache 1233 without indication of the cache residence region from the host 102, whereby it is possible to further accelerate the reading of metadata and further accelerate a processing for making physical volumes usable at the time of host switchover.

The invention made by the inventor of the present invention has been concretely described based on the embodiments of the invention. Needless to say, the present invention is not limited to these embodiments but various changes and modifications can be made to the present invention within the scope of the invention.

Advantages attained by typical inventions among the inventions disclosed in the present application will be briefly described as follows:

(1) The reading of metadata necessary to use logical volumes can be accelerated.

(2) As a result of the advantage (1), system switchover can be accelerated in the hot-standby configuration employing a plurality of computers.

What is claimed is:

1. A metadata allocation method in a computer system, the computer system comprising: one or more computers; and a plurality of physical or logical secondary storage devices, an OS of the computer having: a function of consolidating the plurality of physical or logical secondary storage devices so as to manage the consolidated physical or logical secondary storage device as a logical storage device; and a function of allocating metadata in a first region on the physical or logical secondary storage device in order to manage the consolidated physical or logical secondary storage devices as the logical storage device, the method comprising a step of:
allocating in a second region a copy of the metadata for managing the plurality of physical or logical secondary storage devices as the logical storage device, said second region satisfying a predetermined condition on a fewer number of the physical or logical secondary storage devices than the number of the physical or logical secondary storage regions each having the first region.

2. The metadata allocation method according to claim 1, wherein
the predetermined condition is a condition for allocating each copy of the respective metadata adjacently in the secondary storage devices.

3. The metadata allocation method according to claim 1, wherein
the predetermined condition is a condition set to make the first region to reside in a cache memory of the secondary storage device.

4. A metadata allocation method in a computer system, the computer system comprising: a plurality of computers; and a plurality of physical or logical secondary storage devices, an OS of the computer having: a function of consolidating the plurality of physical or logical secondary storage devices so as to manage the consolidated physical or logical secondary storage device as a logical storage device; and a function of allocating metadata in a first region on the physical or logical secondary storage device in order to manage the consolidated physical or logical secondary storage devices as the logical storage device, the method comprising a step of:
allocating in a second region a copy of the metadata for managing the plurality of physical or logical secondary storage devices as the logical storage device, said second region satisfying a predetermined condition on a fewer number of the physical or logical secondary storage devices than the number of the physical or logical secondary storage regions each having the first region,
wherein the plurality of computers share the plurality of physical or logical secondary storage devices, and in the case where the first computer among the plurality of computers turns into an abnormal status, the copy of the metadata allocated in the second regions is read when the second computer succeeds a processing of the first computer.

5. A metadata allocation method in a computer system, the computer system comprising: one or more computers; and a plurality of physical or logical secondary storage devices, an OS of the computer having: a function of consolidating the plurality of physical or logical secondary storage devices so as to manage the consolidated physical or logical secondary storage device as a logical storage device; and a function of allocating metadata in a region on the physical or logical secondary storage device in order to manage the consolidated physical or logical secondary storage devices as the logical storage device, wherein
the region is set to reside in a cache memory of the secondary storage device.

6. A program for allowing a computer system comprising: one or more computers; and a plurality of physical or logical secondary storage devices, an OS of the computer having: a function of consolidating the plurality of physical or logical secondary storage devices so as to manage the consolidated physical or logical secondary storage device as a logical storage device; and a function of allocating metadata in a first region on the physical or logical secondary storage device in order to manage the consolidated physical or logical secondary storage devices as the logical storage device, to execute a procedure for allocating in a second region a copy of the metadata for managing the plurality of physical or logical secondary storage devices as the logical storage device, said second region satisfying a predetermined condition on a fewer number of the physical or logical secondary storage devices than the number of the physical or logical secondary storage regions each having the first region.

7. A program for allowing a computer system comprising: a plurality of computers; and a plurality of physical or logical secondary storage devices, an OS of the computer having: a function of consolidating the plurality of physical or logical secondary storage devices so as to manage the consolidated physical or logical secondary storage device as a logical storage device; and a function of allocating metadata in a first region on the physical or logical secondary storage device in order to manage the consolidated physical or logical secondary storage devices as the logical storage device, to execute a procedure for allocating in a second region a copy of the metadata for managing the plurality of physical or logical secondary storage devices as the logical storage device, said second region satisfying a predetermined condition on a fewer number of the physical or logical secondary storage devices than the number of the physical or logical secondary storage regions each having the first region,
wherein the plurality of computers share the plurality of physical or logical secondary storage devices, and in the case where the first computer among the plurality of computers turns into an abnormal status, the copy of the metadata allocated in the second regions is read when the second computer succeeds a processing of the first computer.

8. A disk drive comprising one or more physical secondary storage devices, wherein
the disk drive has a function of consolidating the physical secondary storage devices to provide one or more logical secondary storage devices, and comprises a cache memory in which a predetermined region of the one or more logical secondary storage devices is made to reside.
